(19) United States
(12) Patent Application Publication
(10) Pub. No.: US 2008/0289137 A1
(43) Pub. Date: Nov. 27, 2008

(54) AERODYNAMIC WINDSHIELD WIPER ARM

(76) Inventors: Michael Peter Ciaccio, Chelsea, MI (US); Virendra Vilas Gaikwad, Bangalore (IN); William T. Hartsig, Pittsfield, MA (US); Janardhan R. Yandooru, Dearborn, MI (US)

Correspondence Address: SABIC - 08CT;SABIC Innovative Plastics - IP Legal, ONE PLASTICS AVENUE, PITTSFIELD, MA, 01201-3697, US

(21) Appl. No.: 11/753,686

(22) Filed: May 25, 2007

(51) Int. Cl. B60S 1/34; B29C 45/00

(52) U.S. Cl. 15/250.201; 264/239

(57) ABSTRACT

An aerodynamic windshield wiper arm that includes an integrated aerodynamic element that causes down force to be applied to the wiper arm as the air speed across the wiper arm increases, such as in high winds and/or at high speeds. The aerodynamic element is integrally formed with the wiper arm such that it is not easily removed, unlike aerodynamic attachments. The wiper arm is formed using an injection molding process and a plastic material. The aerodynamic element may be in the form of an airfoil or a lip or any other shape capable of causing down force when high winds contact the wiper arm. The one-piece wiper arm provides improved functionality and improved aesthetics over previous wiper arms.

### FIELD OF INVENTION

The present invention relates to windshield wipers for motor vehicles and, in particular, to windshield wipers arms for use on motor vehicles.

### BACKGROUND OF INVENTION

Windshield wipers are often used during periods of heavy rain and wind. In addition, even during light rain, they may be used when the motor vehicle is operating at higher speeds. During these times, it is a frequent occurrence of prior art windshield wipers to lift aerodynamically from the windshield surface. This may be caused in part due to the fact that many windshield wiper arms can act like an airfoil when subjected to high velocity winds, such as those resulting from higher speed operation of the vehicle or high wind storms. Other factors that may contribute to this effect are the use of lighter weight materials in constructing wiper blade arms, the size of the wiper arms, especially on larger motor vehicles, the use of materials that have less tack (and therefore glide more smoothly) for the wiper blades themselves, and motor vehicle aerodynamics. And since windshield wiper down force can be decreased due to aerodynamic forces of the air flow lifting the blade off the windshield or reducing the down force, this decrease in down force of the blade on the windshield can lead to an improper wipe. In addition, metal wiper arms are limited in the geometries that can be formed and require assembly of three separate parts. This can lead to non-aerodynamic shapes that can result in whistling or other noises caused by the wind flowing over that arm. These noises can be distracting and unpleasant for the driver. Finally, as seen in FIG. 5, metal wiper arms 5 are typically formed out of several components such as the retainer 2, extension 3 and blade attachment 4 that require assembly and painting resulting in increased cost.

One solution is to produce a one-piece windshield wiper arm having better aerodynamics that provides a down force to the windshield, less noise and improved aesthetics. The aerodynamic shape has been achieved by attaching (either temporarily or permanently) an aerodynamic structure to the wiper arm. However, the attached devices require some form of attachment means for attaching to the wiper arm, and these attachment means are subject to breakage. In addition, due to the fact that attachment means are used, the aerodynamic structures are more likely to be blown off during sudden gusts of wind. Also, since the aerodynamic structures are added after formation of the wiper arm, the aesthetics are reduced due to the size of the aerodynamic structure. In addition, the attachment feature may cause wind noise from lack of aerodynamic shape. Lastly, due to the size of the aerodynamic structure and the wiper arm, the weight of the overall structure may be greater such that a larger motor is needed to power the wiper arm.

Accordingly, it would be beneficial to provide an aerodynamic windshield wiper arm that eliminated the problems of prior art solutions. It would be beneficial to provide an aerodynamic windshield wiper arm that was lightweight compared to prior art wiper arms with lower cost and wind noise due to elimination of the painting and assembly process (combines retainer, extension and attachment in one part, see attachment). It would also be beneficial to provide an aerodynamic windshield wiper arm that utilized an integrated assembly for improving the aerodynamics of the windshield wiper arm and reducing wind noise without adversely affecting the aesthetics and/or operation of the windshield wiper. The use of plastic also eliminates the possibility of corrosion that can adversely affect performance, life of part and aesthetics.

### SUMMARY OF THE INVENTION

The present invention provides a one-piece aerodynamic windshield wiper arm that includes an integrated aerodynamic element that causes down force to be applied to the wiper arm as the air speed across the wiper arm increases, such as in high winds and/or at high speeds. The windshield wiper arm is designed to have improved aerodynamics as compared to prior art windshield wipers, but without the negatives associated with prior art wiper arms. The improved aerodynamics provides increased down force as a result of the design of the windshield wiper arm. As such, the greater the air speed across the windshield wiper, the greater the downward force.

Accordingly, in one aspect, the present invention provides a one-piece windshield wiper arm including a wiper arm and an aerodynamic element integrally formed with the wiper arm, wherein the wiper arm and the aerodynamic element comprise an organic polymer.

In another aspect, the present invention provides a method of forming a one-piece wiper arm including the step of injection molding an organic polymer to form the wiper arm, wherein the wiper arm comprises a wiper arm and an aerodynamic element integrally formed with the wiper arm.

### BRIEF DESCRIPTION OF THE DRAWINGS

The various embodiments of the present invention can be understood with reference to the following drawings. The components are not necessarily to scale. Also, in the drawings, like reference numerals designate corresponding parts throughout the several views.

FIG. 1 is a perspective view of a one-piece windshield wiper arm according to one embodiment of the present invention.

FIG. 2 is a close-up view of the of the end of the windshield wiper arm with a “J-hook” attachment mechanism according to the embodiment shown in FIG. 1.

FIG. 3 is a perspective view of a windshield wiper arm with an alternate “snap on” attachment mechanism according to another embodiment of the present invention.

FIG. 4 is a close-up view of the bottom of the windshield wiper arm according to the embodiment shown in FIG. 3.

FIG. 5 is a perspective view of a standard prior art wiper arm.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the term “comprising” may include the embodiments “consisting of” and “consisting essentially of” All ranges disclosed herein are inclusive of the endpoints and are independently combinable. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The present invention provides a novel windshield wiper arm that is designed to have improved aerodynamics as compared to prior art windshield wipers, but without the negatives of current solutions for improving windshield wiper aerodynamics. The windshield wipers of the present invention offer improved down force without the use of stiffer springs or clip-on attachments. The improved down force is a result of the design of the windshield wiper arm. As such, the greater the wind on the windshield wiper, the greater the downward force. Therefore, the windshield wiper provides this downward force when needed, and does not supply this force when not needed.

Utilizing an injection molding process, such as a standard injection molding process or a gas or water-assisted injection molding process, the present invention provides a one-piece aerodynamically shaped wiper arm that is formed with a cross-sectional shape designed to increase down force when subjected to higher winds. The injection molding process permits shapes to be formed, including solid shapes and/or to hollow shapes, that are rigid, but lightweight and that cannot be readily achieved at a reasonable cost and weight through a stamping or casting process of metal wiper arms. In addition, the aerodynamic shape is integral to the arm, not an attachment such that the aerodynamic features are not easily removed due to breakage of a mechanical or other fastener. Lastly, secondary processes such as painting, machining, coating and other processes are generally not required after injection molding unlike prior art wiper arms constructed from metal.

Accordingly, in a first aspect, the present invention provides a one-piece aerodynamic windshield wiper that includes a wiper arm that is injection molded. As such, the wiper arm is constructed from an organic polymer capable of being injected molded. In one embodiment, the organic polymer may be selected from a wide variety of thermoplastic resins, blend of thermoplastic resins, thermosetting resins, or blends of thermoplastic resins with thermosetting resins. The organic polymer may also be a blend of polymers, copolymers, terpolymers, or combinations including at least one of the foregoing organic polymers. Examples of the organic polymer include, but are not limited to, polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like, or a combination including at least one of the foregoing organic polymers.

Specific non-limiting examples of blends of thermoplastic resins include acrylonitrile-butadiene-styrene/nylon, polycarbonate/acrylonitrile-butadiene-styrene, polyphenylene ether/polystyrene, polyphenylene ether/polyamide, polycarbonate/polyester, polyphenylene ether/polyolefin, and combinations including at least one of the foregoing blends of thermoplastic resins.

Examples of thermosetting resins include polyurethane, natural rubber, synthetic rubber, epoxy, phenolic, polyesters, polyamides, silicones, and mixtures including any one of the foregoing thermosetting resins. Blends of thermoset resins as well as blends of thermoplastic resins with thermosets can be utilized.

Exemplary examples of the organic polymer include thermoplastic materials that are flexible at temperatures of about 200° C. to about −60° C. Examples of beneficial thermoplastic materials that may be used in the present invention include, but are not limited to, acrylonitrile-butadiene-styrene (ABS), polycarbonate (LEXAN® and LEXAN® EXL resins commercially available from General Electric Company), polycarbonate/ABS blend (CYCOLOY® resins from General Electric Company), a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide (NORYL GTX® resins from General Electric Company), blends of polycarbonate/PET/PBT, polybutylene terephthalate and impact modifier (XENOY® resins commercially available from General Electric Company), polyamides, phenylene sulfide resins, polyvinyl chloride PVC, high impact polystyrene (HIPS), low/high density polyethylene, polypropylene and thermoplastic olefins (TPO), polyethylene and fiber composites, and polypropylene and fiber composites such as AZDEL Superlite™ sheets commercially available from AZDEL, Inc.

Since the one-piece aerodynamic wiper arm is injection molded, it is formed with an aerodynamic element integrally formed with the wiper arm. As used herein, an “aerodynamic element” is a portion of the wiper arm that, due to the shape of the aerodynamic element, results in a down force being applied to the wiper arm as the air speed across the wiper arm increases. As such, during situations of high wind and/or high speeds, the air traveling across the wiper arm contacts the aerodynamic element and causes down force to be applied to the wiper arm and, therefore, the windshield wiper.

The shape of the aerodynamic element may be any shape capable of producing down force to a windshield wiper as the air speed across the wiper arm increases. In one embodiment, the wiper arm has a curved shape, with the end of the curve being the aerodynamic element since wind contacting the end of the wiper arm results in a downward force being applied to the windshield wiper. In another embodiment, the wiper arm has an airfoil shape, similar to the shape of a wing of an airplane. As with the wing of an airplane, as air cross the airfoil, the aerodynamic element in the airfoil results in a downward force being applied to the wiper arm and, therefore, the windshield wiper.

The one-piece windshield wipers of the present invention are made using any process capable of integrating an aerodynamic element with a wiper arm using a plastic material, such as a thermoplastic or thermoset material. In one embodiment, the windshield wiper is constructed using an injection molding process. In the process, molten plastic is injected at high pressure into a mold, which is the inverse of the selected shape of the wiper arm. The mold may be made and/or precision-machined to form the integrated aerodynamic element and the wiper arm. In an alternative embodiment, the injection molding process is could also use gas or water assisted injection molding process that may be used to obtain a hollow shape that is rigid, but lightweight.

The foregoing and other features of the present invention will be more readily apparent from the following detailed description and drawings of the illustrative embodiments of the invention wherein like reference numbers refer to similar elements.

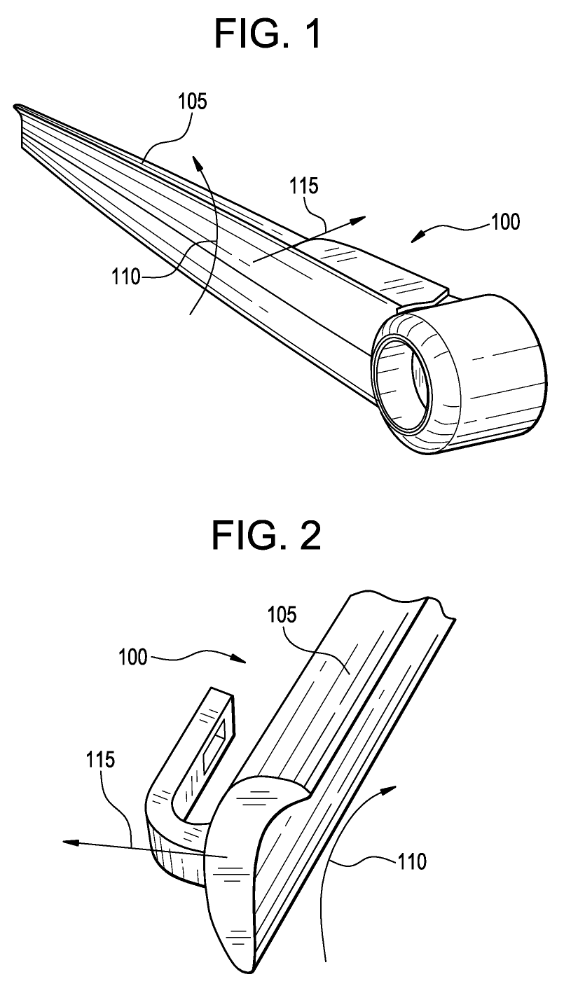

One embodiment of the design is shown in FIGS. 1 and 2. FIGS. 1 and 2 show a wiper arm 100 having an aerodynamic shape that deflects the air upward, therefore providing a downward force on the windshield. In this embodiment, the wiper arm 100 includes a curved shape having an upper lip 105 that is one end of the curved shape. As air (depicted by arrow 110) strikes the wiper arm 100, the air 110 is directed upwards, where it contacts the lip 105. The air 110 contacting the lip 105 causes a down force (depicted by arrow 115) to be applied to the wiper arm 100.

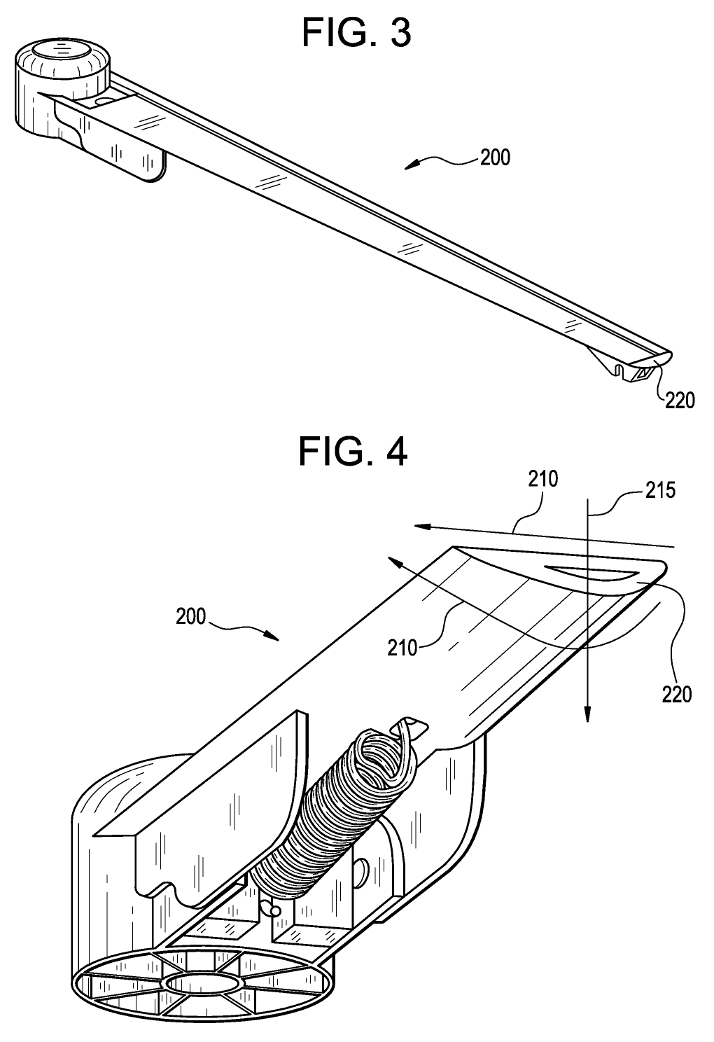

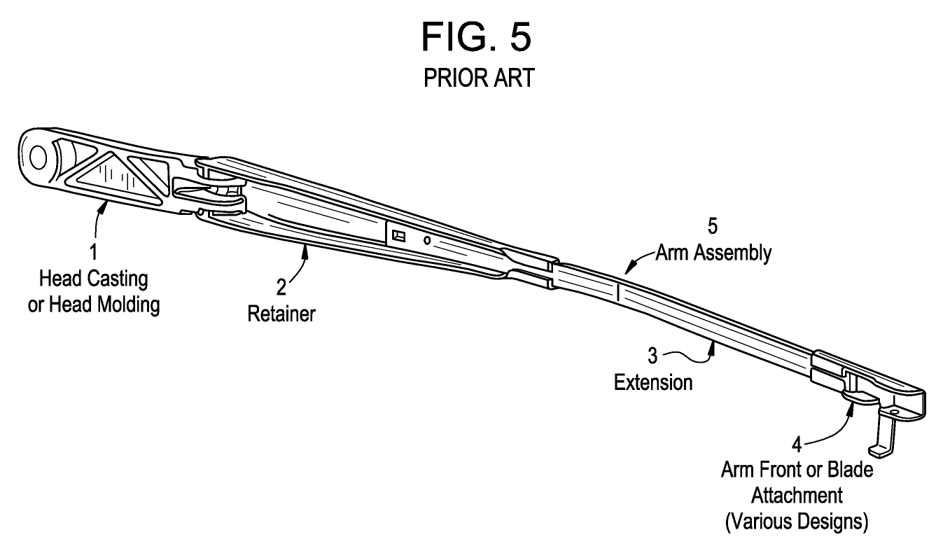

A second embodiment of the invention is shown in FIGS. 3 and 4. These figures show a wiper arm 200 having a “spoiler” design 220 (inverted airfoil or wing) that creates a downward force 215 on the wiper arm 200 by air 210 flowing over the top and bottom of the wiper arm 200 creating a low-pressure area below the spoiler 220. As such, this low-pressure area results in higher pressure above the wiper arm 200 than below, thereby causing the downward force 215.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A one-piece windshield wiper arm comprising:
a wiper arm; and
an aerodynamic element integrally formed with the wiper arm;
wherein the wiper arm and the aerodynamic element comprise an organic polymer.

2. The windshield wiper arm of claim 1, wherein the organic polymer is selected from a thermoplastic resin, a blend of thermoplastic resins, a thermosetting resin, or a blend of a thermoplastic resin with a thermosetting resin.

3. The windshield wiper arm of claim 2, wherein the organic polymer is selected from polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like, or a combination including at least one of the foregoing organic polymers.

4. The windshield wiper arm of claim 2, wherein the organic polymer is selected from acrylonitrile-butadiene-styrene (ABS), polycarbonate, polycarbonate/ABS blend, a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide, blends of polycarbonate/PET/PBT, polybutylene terephthalate and impact modifier, polyamides, phenylene sulfide resins, polyvinyl chloride PVC, high impact polystyrene (HIPS), low/high density polyethylene, polypropylene and thermoplastic olefins (TPO), polyethylene and fiber composites, polypropylene and fiber composites, or a combination thereof.

5. The windshield wiper arm of claim 1, wherein the wiper arm has a curved shape and the aerodynamic element comprises one end of the curved wiper arm.

6. The windshield wiper arm of claim 1, wherein the wiper arm has a shape of a spoiler and the aerodynamic element comprises an airfoil.

7. A method of forming a one-piece wiper arm comprising the steps of:
injection molding an organic polymer to form the wiper arm;
wherein the wiper arm comprises a wiper arm and an aerodynamic element integrally formed with the wiper arm.

8. The method of claim 7, wherein the organic polymer is selected from a thermoplastic resin, a blend of thermoplastic resins, a thermosetting resin, or a blend of a thermoplastic resin with a thermosetting resin.

9. The method of claim 8, wherein the organic polymer is selected from polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like, or a combination including at least one of the foregoing organic polymers.

10. The method of claim 8, wherein the organic polymer is selected from acrylonitrile-butadiene-styrene (ABS), polycarbonate, polycarbonate/ABS blend, a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide, blends of polycarbonate/PET/PBT, polybutylene terephthalate and impact modifier, polyamides, phenylene sulfide resins, polyvinyl chloride PVC, high impact polystyrene (HIPS), low/high density polyethylene, polypropylene and thermoplastic olefins (TPO), polyethylene and fiber composites, polypropylene and fiber composites, or a combination thereof.

11. The method of claim 7, wherein the wiper arm has a curved shape and the aerodynamic element comprises one end of the curved wiper arm.

12. The method of claim 7, wherein the wiper arm has a shape of a spoiler and the aerodynamic element comprises an airfoil.

13. The method of claim 7, wherein the injection-molding step is a selected from a gas-assistant injection-molding process or water assisted injection-molding process.
